(19) United States
(12) Patent Application Publication
(10) Pub. No.: US 2019/0327980 A1
(43) Pub. Date: Oct. 31, 2019

(54) AUTOMATIC MACHINE FOR MAKING FLAT EDIBLES

(71) Applicant: MIRAJ BUSINESS DEVELOPMENT PVT LTD, Nathdwara (IN)

(72) Inventors: Madan Lai Paliawl, Nathdwara (IN); Sushila Devi Paliwal, Nathdwara (IN)

(73) Assignee: MIRAJ BUSINESS DEVELOPMENT PVT LTD, Nathdwara (IN)

(21) Appl. No.: 15/999,861

(22) PCT Filed: Feb. 18, 2017
(86) PCT No.: PCT/IN2017/050068

§ 371 Date: Aug. 20, 2018

(30) Foreign Application Priority Data
Feb. 20, 2016 (IN) 201611005947

(51) Int. Cl. A21C 11/00; A21C 1/14; A21C 1/00

(52) U.S. Cl. CPC A21C 11/006; A21C 1/003; A21C 1/1405

(57) ABSTRACT

Present Automatic machine for making flat edibles (1) mainly comprises of Dispensing module (2), Kneading Module (3), Dough-arm Module (4), Pressing Module (5), Flat edible arm Module (6), Baking Module (7), Electronic Module (8), Body and Structural parts (9). Said Dispensing module (2) is provided to dispense the raw materials for preparing the flat edibles wherein said raw materials generally, but not exclusively include flour, water and oil, said Kneading Module (3) is for kneading of raw materials dispensed, said Dough-arm Module (4) transfers the dough from Kneading module (3) to Pressing Module (5), said Pressing Module (5) facilitates in pressing the dough into flat round edible, said Flat edible arm Module (6) transfers flat round edible from the Pressing Module (5) to Baking Module (7) and Baking Module (7) to outside tray, said Electronic module (8) controls the working of present Automatic machine for making flat edibles (1).

### FIELD OF INVENTION

The present invention relates to an automatic machine for making flat edibles. More particularly, the present invention relates to compact, automatic machine for making flat edibles that automatically dispenses flat edibles that are ready to eat; it further facilitates cleaning of its component parts thereby enabling maintenance of hygienic condition. Present automatic machine for making flat edibles is portable, efficient, safe and cost-effective.

### BACKGROUND AND PRIOR ART

In many countries of the world like India, many of the food items; commonly amongst the edibles of normal diet of an average person at least consists of a few amongst variety of flat edibles more preferably rotis, chapattis, tortillas, etc. The general process for making of flat edibles is not only time consuming but also cumbersome. The process involves proper assortment of raw ingredients (flour, ghee, oil, water), kneading the mixture in a dough, making of flat bread and then cooking over tavas. This makes the process time consuming and cumbersome.

Various efforts have been made to develop equipments that facilitate said process with objectives to make the process less cumbersome and less time consuming. However, said equipments fails to provide complete process of making flat edibles in one automated machine.

There have been developments of following prior art equipments:
Baking plates are one of the common machines trying to address the automation of making flat edibles. It is available in the market and is used in pressing and baking of the dough to result into flat edibles; wherein the round dough ball is placed between the plates, is pressed and cooked. However said machine involves manual kneading of the dough and thereby fails to add ease in the process of making flat edibles.
U.S. Pat. No. 4,854,847 describes Tortilla dough forming machine: The machine is used to prepare dough for making tortillas. Dough forming process generally involves the mixing of flour, oil and water in required amounts to form dough; portions of which are further manually kneaded to obtain dough balls; which are further pressed or rolled into a spherical shape. Said Tortilla dough forming machine is only used to make the dough automatically for which said machine has a hopper hollow extension and hollow casing mounted in a serial arrangement on a support frame.
However, said machine fails to provide a fully automated machine for making of flat edible and only facilitates the kneading of dough. Moreover the machine is bulky and fails to facilitate pressing and baking of flat edibles. Also the cleaning of the said machine is difficult thus fails to provide hygienic conditions.
U.S. Pat. No. 7,547,206 B2 describes Dough processing apparatus: The said machine is a dough processing apparatus capable of not only stably thinning and shaping dough, such as a pizza dough, and so forth, into a thin sheet-like shape, but also coping with dough in a wide variety of shapes with ease. A rounded dough obtained by portioning out dough to a predetermined quantity is transferred toward under a first beating mechanism, and a second beating mechanism by a belt conveyor. The first beating mechanism, and the second beating mechanism make the vertical movement, alternately, whereupon the dough f is pressed under pressure to be thereby thinned. The dough f after thinned is then transferred by the belt conveyor to be delivered to a dough-shaping apparatus. The dough f is transferred by a belt conveyor to be surrounded by a horizontal die. The dough f as surrounded by the horizontal die is pushed down from above by a rotator provided with a plurality of push-rollers. Upon rotation of the rotator, the dough f is thinned by the plurality of the push-rollers to be thereby shaped into a shaped dough F in the shape of a thin sheet, circular in a plan view.
However, said machine fails to provide the automated kneading process, to make dough and thereby fails to provide ease in the complete process of making flat edibles. Further it fails to provide automated baking process for baking of the flat edible and thus fails to provide a fully automated machine for making flat edibles. Moreover the said machine is bulky and also the cleaning of the component parts of said machine is difficult thus fails to provide hygienic conditions.
US 2012/034360A1 describes Compact appliance for making flat edibles: The said machine is a compact apparatus for automatically making a plurality of flat edibles includes a storage and dispensing unit that makes it unnecessary for a user to pre-measure ingredients. The apparatus also includes a mixing and kneading unit for making dough of optimal consistency. The mixing and kneading unit may be configured to prepare dough. The dough may be prepared by mixing and kneading the ingredients dispensed by the dispensers. The dough prepared may be transferred onto a lower platen from a transfer base by a transfer sweeper. The dough may be flattened in a platen unit. An upper platen and the lower platen of the platen unit may be heated to a pre-programmed temperature for cooking the flat edible. The temperature may also be manually set by the user based on user's preference. The flat may be cooked (e.g. heated, roasted and/or puffed) by the platen unit.
However said machine fails to provide information about the overheating of sensor and thus fails to auto stop the machine in case of overheating. Moreover it fails to facilitate cleaning mechanism and thus fails to provide and maintain hygienic condition.

Thus, none of the said machines are able to provide a compact automatic machine for making flat edibles and further fails to provide proper hygienic conditions.

### DISADVANTAGES OF PRIOR ART

The existing machines for making flat edibles suffer from at least one of the following disadvantages:
1. Most of them fails to provide a fully automatic machine for making flat edibles.
2. Most of them fails to eliminate the requirement of manual process of dough kneading and thus fails to provide the automatic mechanism for kneading of spherical dough.
3. Most of them fail to address the limitation of accuracy and uniformity in the process of making flat edibles; wherein, through the use of traditional manual methods of preparing flat edibles, accuracy or uniformity of size and shape remains unaddressed.
4. Most of them fails to provide modular structure machine which further fails to facilitate assembling and disassembling of the component parts of said machine and thus fails to maintain cleanliness and hygienic conditions.
5. Most of them fail to provide the access for cleaning of the component parts that comes in contact of the raw materials i.e. flour, water, oil and thereby fails to maintain the hygienic conditions.
6. Most of them fail to provide automatic control of the machine.

Thus, there is a need to develop a fully automated, cost effective, portable and safe machine for making flat edibles.

### OBJECTIVES OF INVENTION

The primary object of the invention is to provide an automatic machine for making flat edibles which is compact, automatic machine for making flat edibles that automatically dispenses flat edibles that are ready to eat.

Another object of the present invention is to provide an automatic machine for making flat edibles, that further facilitates cleaning of its component parts thereby enabling maintenance of hygienic condition.

Yet another object of the present invention is to provide an automatic machine for making flat edibles, that is portable, efficient and cost-effective.

Yet another object of the present invention is to provide an automatic machine for making flat edibles, that eliminates the requirement of manual process of dough kneading and thus provides the automatic mechanism for kneading of spherical dough.

Yet another object of the present invention is to provide an automatic machine for making flat edibles, that addresses the limitation of accuracy and uniformity in the process of making flat edibles.

Yet another object of the present invention is to provide an automatic machine for making flat edibles, that eliminates the use of traditional manual methods of preparing flat edibles, and provide accuracy or uniformity of size and shape.

### BRIEF DESCRIPTION OF DRAWINGS

| FIG. | Shows the isometric front view of the present automatic |
|---|---|
| 1.1 | machine for making flat edibles. |
| FIG. | Shows the isometric back view of the present automatic |
| 1.2 | machine for making flat edibles. |
| FIG. | Shows the isometric full view of the Dispensing Module |
| 2.1 | of the present automatic machine for making flat edibles. |
| FIG. | Shows the fragmented view of the Dispensing Module of |
| 2.2 | the present automatic machine for making of flat edibles. |
| FIG. | Shows the isometric full view of the Kneading Module of |
| 3.1 | the present automatic machine for making flat edibles. |
| FIG. | Shows the fragmented view of Kneading Module of the |
| 3.2 | present automatic machine for making flat edibles. |
| FIG. | Shows the isometric full view of the Dough-arm Module |
| 4.1 | of the present automatic machine for making flat edibles. |
| FIG. | Shows the fragmented view of the Dough-arm Module of |
| 4.2 | present automatic machine for making flat edibles. |
| FIG. | Shows the isometric full view of the Pressing Module of |
| 5.1 | the present automatic machine for making flat edibles. |
| FIG. | Shows the fragmented view of the Pressing Module of the |
| 5.2 | present automatic machine for making flat edibles. |
| FIG. | Shows the isometric full view of the Flat edible arm |
| 6.1 | Module of the present automatic machine for making flat |
| | edibles. |
| FIG. | Shows the fragmented view of the Flat edible arm |
| 6.2 | Module of the present automatic machine for making flat |
| | edibles. |
| FIG. | Shows the isometric full view of the Baking Module of the |
| 7.1 | present automatic machine for making flat edibles. |
| FIG. | Shows the fragmented view of the Baking Module of the |
| 7.2. | present automatic machine for making flat edibles. |

### MEANING OF REFERENCE NUMERALS OF SAID COMPONENT PARTS OF PRESENT INVENTION

1: Present Automatic Machine For Making Flat Edibles
2: Dispensing Module
2A: Screw Conveyor Holder
2B: Screw Conveyor
2C: Conveyor Motor
2D: Agitator Motor
2E: Agitator Female Coupling A
2F: Agitator Male Coupling
2G: Agitator Female Coupling B
2H: Jar Locking Disc
2I: Flour Jar Disc
2J: Flour Jar
2K: Fins
2L: Water Jar
2M: Liquid Non Return Valve
2N: Valve Push Pin
2O: Oil Jar
2P: Peristaltic pump
2Q: Flour Spread Stopper
2R: Sensor
3: Kneading Module
3A: Up-Down Platform
3B: Lead Screw
3C: Coupling
3D: Sheet Metal Bracket
3E: Up-Down Motor
3F: Pressure Pad
3G: Dough Base Motor
3H: Dough Swivel
3I: Dough Base
3J: Dough Cup
3K1: Kneader
3K2: Magnet 1
3L: Dough Cup Holder
3M1: Kneader Holder
3M2: Magnet 2
3N: Motor Base
3O: Motor
3P1: Upper Limit Switch
3P2: Lower Limit Switch
4: Dough-arm Module
4A: Dough Fixed Arm
4B: Roller Arm
4C: Long Roller
4D: Short Roller
4E: Dough-arm Motor
4F: Dough-arm Motor Cover
4G: Roller Motor
5: Pressing Module
5A: Guide Rail
5B: Guide Block
5C: Pressing Lower Tawa Assembly
5D: Pressing Upper Tawa Assembly
5E: Pressing Actuator Assembly
5F1: Upper Temperature Sensor
5F2: Lower Temperature Sensor
5G: Pressing Motor
5H: Pressing Motor Base
5I: Sheet Metal Bracket
5J: Sheet Metal Bracket
5K1: Sensor
5K2: Sensor
6: Flat edible Arm Module
6A: Pusher
6B: Horizontal arm
6C: Dough Locator
6D: Vertical arm
6E: Pulley A
6F: Pulley B
6G: Wire Rope
6H: Flat edible Arm Motor
6I: Guide Block
6J: Rail Guide
6K: Flat edible Arm Body
6L: U Clip
6M1: Sensor 1
6M2: Sensor 2
7: Baking Module
7A: Baking Lower Tawa Assembly
7B: Baking Upper Tawa Assembly
7C: Baking Actuator Assembly
7D: Baking Motor
7E1: Upper Temperature Sensor
7E2: Lower Temperature Sensor
7F: Guide Block
7G1: Sensor
7G2: Sensor
7H: Sheet Metal Bracket
7I: Sheet Metal Bracket
8: Electronic Module
8A: Controller Card PCB
8B: Switched Mode Power Supply (SMPS)
8C: Display LCD
8D: Keyboard
9: Body and Structural parts
9A: Enclosure Panels
9B: Top Plate
9C: Bottom Plate
9D: Pillars
9E: Sheet Metal Cage

### DETAILED DESCRIPTION OF INVENTION

The embodiment of the present invention is to provide an automatic machine for making flat edibles, that automatically dispenses flat edibles that are ready to eat; it further facilitates cleaning of its component parts thereby enabling maintenance of hygienic condition. Present automatic machine for making flat edibles is portable, efficient and cost-effective.

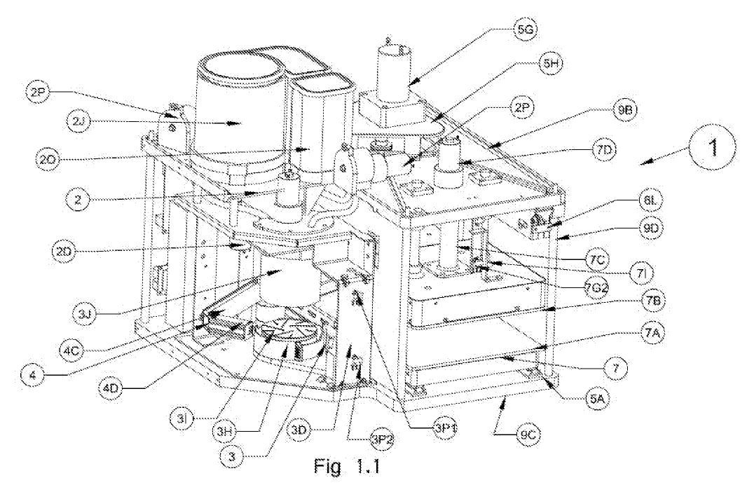

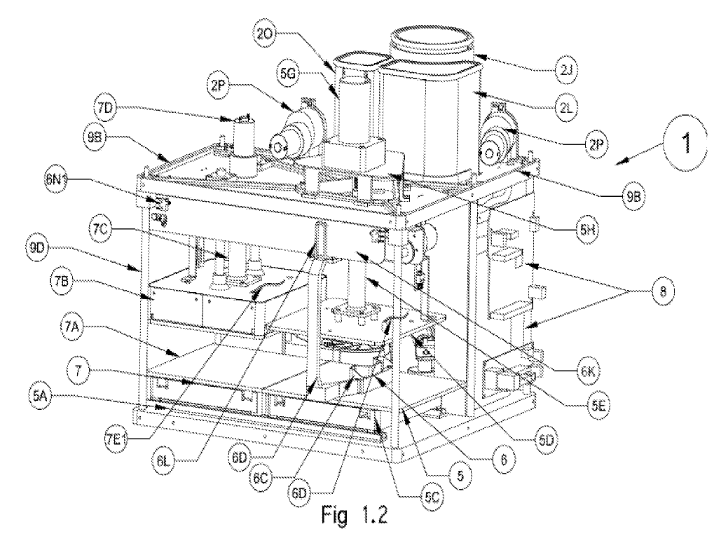

Referring to FIG. 1.1, FIG. 1.2, the present automatic machine for making flat edibles (1) mainly comprises of:
Dispensing Module
Kneading Module
Dough-arm Module
Pressing Module
Flat edible arm Module
Baking Module
Electronic Module
Body and Structural Part

Wherein:

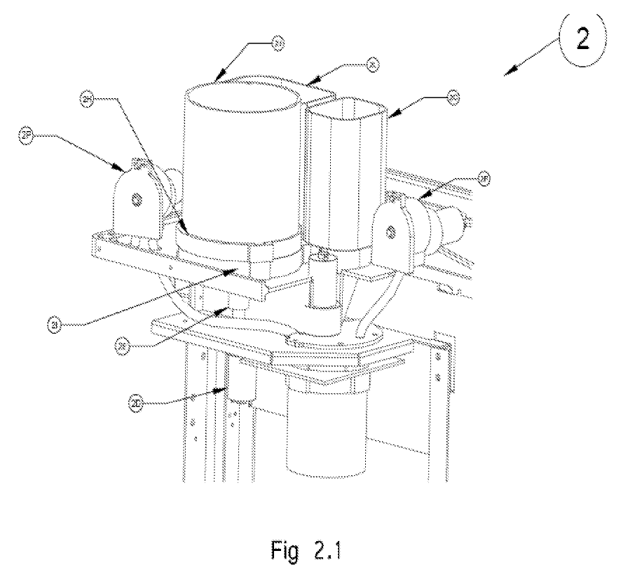

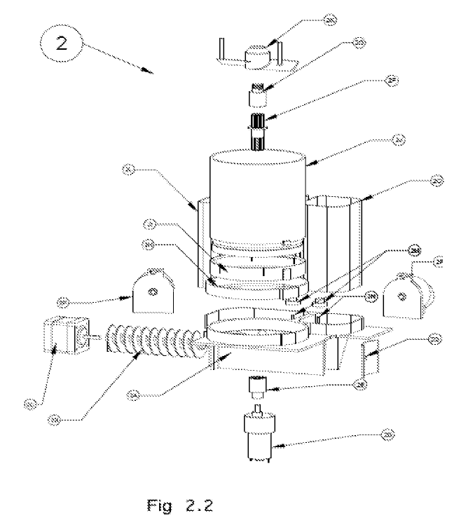

Referring to FIG. 2.1 and FIG. 2.2 the Dispensing Module (2) is provided to dispense the raw materials in the present automatic machine for making flat edibles (1) for preparing the flat edibles. Said raw materials generally, but not exclusively include flour, water and oil. Said Dispensing Module (2) further comprises of:
Screw Conveyor Holder (2A)
Screw Conveyor (2B)
Conveyor Motor (2C)
Agitator Motor (2D)
Agitator Female Coupling A (2E)
Agitator Male Coupling (2F)
Agitator Female Coupling B (2G)
Jar Locking Disc (2H)
Flour Jar Disc (2I)
Flour Jar (2J)
Fins (2K)
Water Jar (2L)
Liquid Non Return Valve (2M)
Valve Push Pin (2N)
Oil Jar (2O)
Peristaltic pump (2P)
Flour Spread Stopper (2Q)
Sensor (2R)

Referring to FIGS. 2.1 to 2.2, said Screw Conveyer holder (2A) made of food grade high strength plastic; which includes Polyethylene Terephthalate (PET), Polypropylene (PP), High-Density Polyethylene (HDPE), Low-Density Polyethylene (LDPE), Polycarbonate (PC), Nylon, Acrylonitrile Butadiene Styrene (ABS) and alike. It is mounted on a top plate (9B). A Screw Conveyor (2B) made of food grade high strength plastic which includes Polyethylene Terephthalate (PET), Polypropylene (PP), High-Density Polyethylene (HDPE), Low-Density Polyethylene (LDPE), Polycarbonate (PC), Nylon, Acrylonitrile Butadiene Styrene (ABS) and alike; is provided, to smoothly meter and transfer the amount of flour needed for making of flat edibles based on the input from the Controller Card PCB (8A). Said Screw conveyor (2B) is held inside the Screw Conveyer holder (2A). Said Screw conveyor (2B) is controlled by the Conveyor Motor (2C) which in turn is attached to a Sensor (2R). Said Flour Spread Stopper (2Q) is attached to the said Screw Conveyor Holder (2A) and is provided to stop extra flour spreading. A Flour Jar (2J) made up of food grade high strength plastic which includes Polyethylene Terephthalate (PET), Polypropylene (PP), High-Density Polyethylene (HDPE), Low-Density Polyethylene (LDPE), Polycarbonate (PC), Nylon, Acrylonitrile Butadiene Styrene (ABS) and alike, is provided to facilitate easy lift out without spilling the flour inside the said machine with the lid to load the dry flour for making flat edibles. Said Flour Jar (2J) is attached to the Flour Jar Disc (2I). Said Flour Jar Disc (2I) is attached to the said Screw Conveyer Holder (2A) on the top side. Further a Jar Locking Disc (2H) is attached to the said Screw Conveyer Holder (2A) on the bottom side. Said Flour jar (2J) is mounted on a Top Plate (9B). Fins (2K), an Agitator Female Coupling A(2E), an Agitator Male Coupling (2F) and an Agitator Female Coupling B(2G) are attached to a Agitator Motor (2D) in the center of said Flour Jar (2J). Said Agitator motor (2D) is regulated by Controller Card PCB (8A) to regulate the process of dispensing. A Water Jar (2L) made up food grade high strength plastic which includes Polyethylene Terephthalate (PET), Polypropylene (PP), High-Density Polyethylene (HDPE), Low-Density Polyethylene (LDPE), Polycarbonate (PC), Nylon, Acrylonitrile Butadiene Styrene (ABS) and alike, is provided for storing of water required in the process of making of flat edibles. Said Water jar (2L) is mounted on a Top Plate (9B). An Oil Jar (2O) made up food grade high strength plastic which includes Polyethylene Terephthalate (PET), Polypropylene (PP), High-Density Polyethylene (HDPE), Low-Density Polyethylene (LDPE), Polycarbonate (PC), Nylon, Acrylonitrile Butadiene Styrene (ABS) and alike, is provided for storing of oil, molten butter, molten ghee or alike required in the process of making of flat edibles. Said Oil Jar (2O) is mounted on a Top Plate (9B). A Liquid non return Valve (2M) is attached to the said Water Jar (2L) and the Oil Jar (2O). Said Liquid non return Valve (2M) is activated by the Valve Push Pin (2N) when said Water Jar (2L) or Oil Jar (2O) is mounted on Top Plate (9B). A pair of Peristaltic Pump (2P) made of food grade material which includes Polyethylene Terephthalate (PET), Polypropylene (PP), High-Density Polyethylene (HDPE), Low-Density Polyethylene (LDPE), Polycarbonate (PC), Nylon, Acrylonitrile Butadiene Styrene (ABS) and alike, is provided for dispensing of water and oil from the said Water jar (2L) and Oil jar (2O). Said whole arrangement is mounted on a top plate (9B).

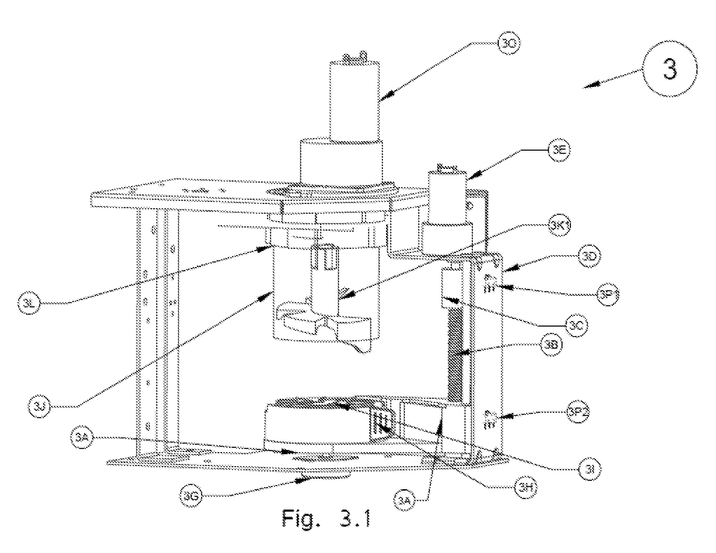

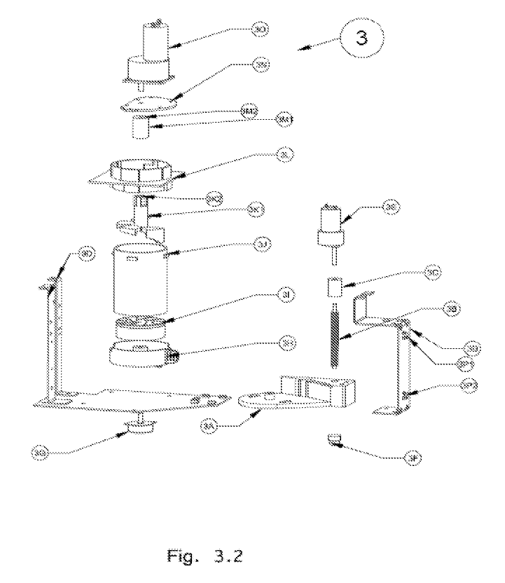

Referring to FIG. 3.1 and FIG. 3.2, the Kneading Module (3) is provided for mixing and kneading of raw materials dispensed in said module (3) through dispensing module (2). Said Kneading Module (3) facilitates in making of spherical shape dough in the present automatic machine for making flat edibles (1). Said raw materials generally, but not exclusively include flour, water and oil. Said Kneading Module (3) is comprised of:
Up-Down Platform (3A)
Lead Screw (3B)
Coupling (3C)
Sheet Metal Bracket (3D)
Up-Down Motor (3E)
Pressure Pad (3F)
Dough Base Motor (3G)
Dough Swivel (3H)
Dough Base (3I)
Dough Cup (3J)
Kneader (3K1)
Magnet 1 (3K2)
Dough Cup Holder (3L)
Kneader Holder (3M 1)
Magnet 2 (3M2)
Motor Base (3N)
Motor (3O)
Upper Limit Switch (3P1)
Lower Limit Switch (3P2)

Said Kneader (3K1) and magnet 1 (3K2) is provided that facilitates the rotating mechanism and mixes the said raw materials into a spherical dough. Said raw materials generally, but not exclusively include flour, water and oil. Said Kneader (3K1) is attached to Kneader holder (3M1) and Magnet 2 (3M2). Said Kneader (3K1) is a specifically designed finger like structure, more preferably 5 fingers or 4 fingers or 3 fingers like structure based on the size and output of the machines, simulating the movements of human hand. Said Kneader (3K1) and magnet 1(3K2) is controlled by a Motor (3O) which in turn is controlled by the said Controller card PCB (8A). Said Kneader (3K1) and magnet 1(3K2) rotates inside the Dough cup (3J), having four holding bosses and is open from the top as well as the bottom side. Said Dough cup (3J) is attached to the Dough cup Holder (3L). Said dispensed raw materials are held inside the Dough cup (3J) and on Dough Base (3I). Said Dough Base (3I) having a ribbed surface on the top face and grooves on cylindrical face is attached to the said Dough Base Motor (3G) and said Dough Swivel Base (3H) which in turn is attached to the Up-Down Platform (3A). Said Dough base (3I) is provided to hold the said Dough cup (3J). Said Up-down Platform (3A) is attached to the Dough base Motor (3G). Said Dough Base Motor (3G) is controlled by the said Controller card PCB (8A). A Lead Screw (3B) driven by the Up-down motor (3E) is provided to facilitate the up down movement of the said Up-Down Platform (3A). Coupling (3C) is provided for absorbing shocks and jerks during up and down movements of the said up down platform (3A) and during Kneading operations. Said Kneader (3K1), Dough cup (3J), Dough Base (3I) and Dough swivel Base (3H) have been designed such that it can be detached easily and thereby ease the process of cleaning of the said component parts thus, maintains hygienic conditions.

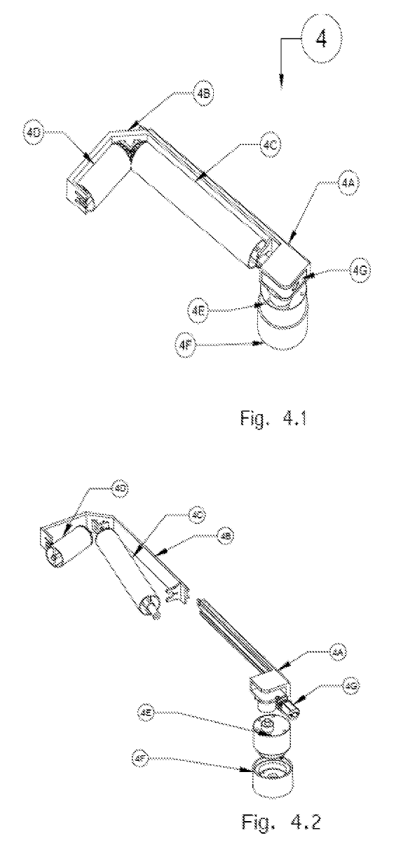

Referring to FIG. 4.1 and FIG. 4.2, the Dough-arm Module (4) is provided to transfer the said spherical dough at a position that ease the process of making flat edibles and then returns back to the home position of said dough arm module. Said module is comprised of:
Dough Fixed Arm (4A)
Roller Arm (4B)
Long Roller (4C)
Short Roller (4D)
Dough Arm Motor (4E)
Dough Arm Motor Cover (4F)
Roller Motor (4G)

Said Dough fixed arm (4A) is provided to facilitate the transfer of spherical dough to the Pressing Module (5). Said Dough fixed arm (4A) rotates at an angle in the range of 0-200°. Said Dough fixed arm (4A) is attached to the Dough arm Motor (4E) which in turn is attached to the Dough arm Motor Cover (4F). Said Dough arm Motor Cover (4F) consists of a sensor for sensing the home position of the Dough fixed Arm (4A). A Roller arm (4B) is attached to the said Dough fixed arm (4A). Long Roller (4C) and Short Roller (4D) made up of food grade plastic which includes Polyethylene Terephthalate (PET), Polypropylene (PP), High-Density Polyethylene (HDPE), Low-Density Polyethylene (LDPE), Polycarbonate (PC), Nylon, Acrylonitrile Butadiene Styrene (ABS) and alike, is provided in a specific “L” shaped arrangement to facilitate the smooth transfer of the spherical dough and is attached to the said Roller arm (4B). Said specific “L” shaped arrangement further facilitates the movement of the said rollers and guide the dough during the transfer. Said Roller motor (4G) is provided to facilitate the rollers to rotate and aid in the process of transferring the spherical dough. Said Roller Motor (4G) is attached to Long roller (4B) and Dough fixed arm (4A).

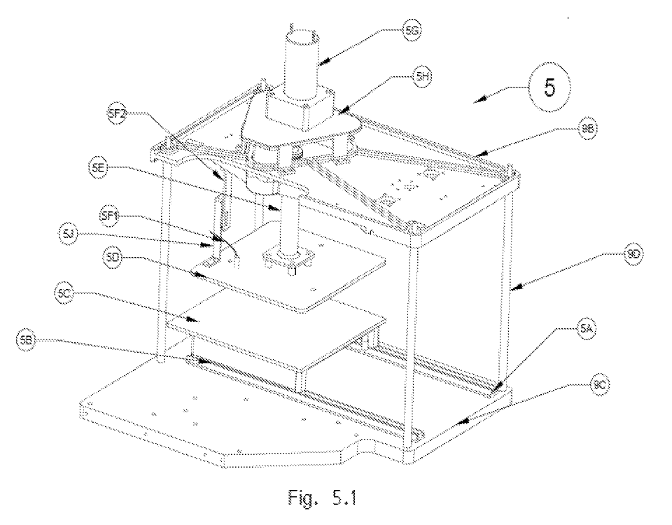

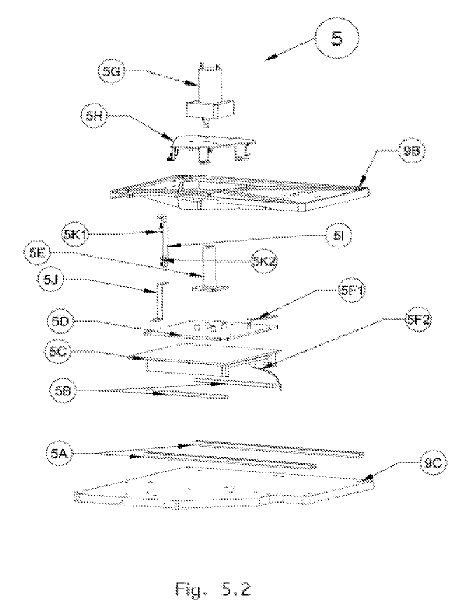

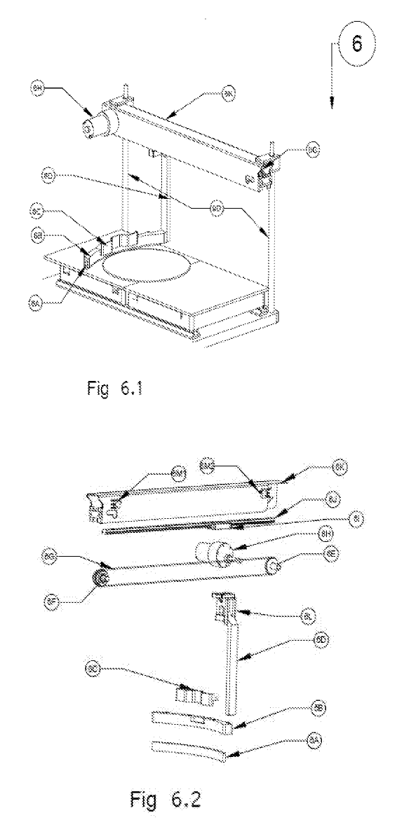

Referring to FIG. 5.1 and FIG. 5.2, the Pressing Module (5) is provided which facilitates in the complete process of making of flat edibles in the present automatic machine for making flat edibles (1), by pressing the spherical dough transferred by the said Dough Arm Module (4) into a flat round edible. Said module is comprised of:
Guide Rail (5A)
Guide Block (5B)
Pressing Lower Tawa Assembly (5C)
Pressing Upper Tawa Assembly (5D)
Pressing Actuator Assembly (5E)
Upper Tawa Temperature Sensor (5F1)
Lower Tawa Temperature Sensor (5F2)
Pressing Motor (5G)
Pressing Motor Base (5H)
Sheet Metal Bracket (5I)
Sheet Metal Bracket (5J)
Sensor (5K1)
Sensor (5K2)

Said Pressing Module (5) comprises of a pair of tawas, Lower Tawa Assembly (5C) and Pressing Upper Tawa Assembly (5D). Surfaces of said pair of tawas coming in contact with the said spherical dough are smooth and coated with heat resistant non-stick food grade material which includes Polytetrafluroethylene (PTFE) and alike. Said Pressing Lower Tawa Assembly (5C) is a fabricated box shape structure having heat source located inside. Said Heat source is attached to top surface of the said Pressing Lower Tawa Assembly (5C). Said Pressing Upper tawa Assembly does not consists of heat source. The bottom side of the said heat source is surrounded with heat resisting material which includes glass wool, ceramic wool, mineral wool, ceramic cloth and alike in order to minimize heat losses due to convection. Said heat source can be in varied range of shapes more preferably in a zig-zag, z type or circular shape. Said Pressing lower Tawa Assembly (5C) is attached to a Guide Block (5B), which further slides inside Guide Rail (5A). Said Guide Rail (5A) is attached to a Bottom Plate (9C). Said Pressing Upper tawa Assembly (5D) is attached to the Pressing Actuator Assembly (5E), which in turn attached to the Pressing Motor (5G). Said Pressing Motor (5G) is attached to the Pressing Motor Base (5H) and is mounted on a top plate (9B). Sheet Metal Bracket (5I) and Sheet Metal Bracket (5J) are provided to hold the sensors. Said Sheet Metal Bracket (51I) is attached at the bottom side of a Top Plate (9B). Said sensors, Sensor (5K1) and Sensor (5K2) are held inside the Sheet Metal Bracket (51I). Said Sheet Metal Bracket (5J) is attached to the Pressing Upper tawa Assembly (5D). Upper Tawa Temperature Sensor (5F1) and Lower Tawa Temperature Sensor (5F2) are attached to the said Pressing Upper tawa Assembly (5D) and Pressing Lower Tawa Assembly (5C) respectively.

Referring to Fig (6.1) and (6.2), the Flat edible arm Module (6) is provided to transfer the said flat round edible from the Pressing Module (5) to the Baking Module (7). Said module is also used to transfer the baked edible from the Baking Module (7) to an outside tray and thus facilitate in the completing the process for making of flat edibles. Said Flat edible-arm Module (6) is comprised of:
Pusher (6A)
Horizontal arm (6B)
Dough Locator (6C)
Vertical arm (6D)
Pulley A (6E)
Pulley B (6F)
Wire Rope (6G)
Flat edible arm Motor (6H)
Guide Block (6I)
Rail Guide (6J)
Flat edible arm Body (6K)
U Clip (6L)
Sensor 1 (6M1)
Sensor 2 (6M2)

Said Pusher (6A) made up of food grade material which includes Polyethylene Terephthalate (PET), Polypropylene (PP), High-Density Polyethylene (HDPE), Low-Density Polyethylene (LDPE), Polycarbonate (PC), Nylon, Acrylonitrile Butadiene Styrene (ABS) and alike, and Dough Locator (6C) are mounted on the Horizontal arm (6B). Said Horizontal arm (6B) is attached to the Vertical Arm (6D). Said arms further facilitate the motion in the transfer of flat edibles. Said Vertical Arm (6D) is connected to the U Clip (6L). Said U Clip (6L) is attached to the Guide Block (6I) which in turn is attached to the Rail Guide (6J) and Wire Rope (6G). Said Wire Rope (6G) is attached to a pair of pulleys; Pulley A (6E) and Pulley B (6F) which in turn are connected to the said rail Guide (6J). Said Wire Rope (6G) facilitates the linear motion of Rail Guide (6J). A pair of sensors, Sensor (6M1) and Sensor (6M2) are attached to the side ends of the Flat edible arm Body (6K). Said sensors (6M1) and (6M2) are regulated by the Controller Card PCB (8A). Said Flat edible arm Motor (6H) is attached to the Pulley A (6E). The entire Flat edible arm Module (6) is held inside the Bottom Plate (9C) through a pair of Pillars (9D).

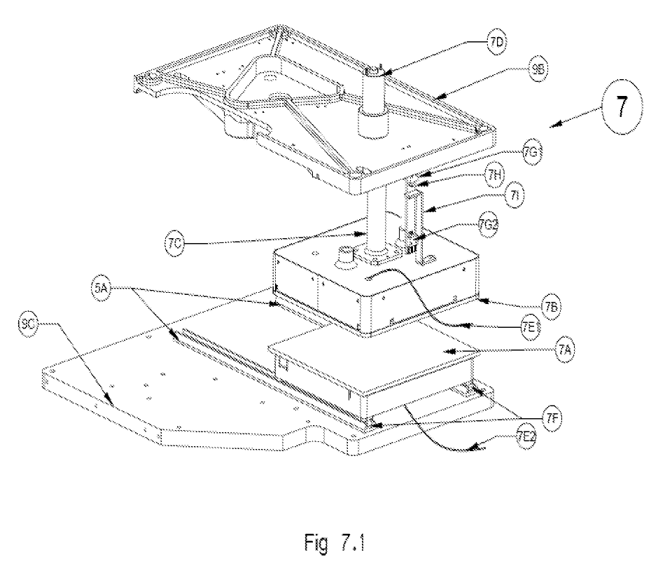

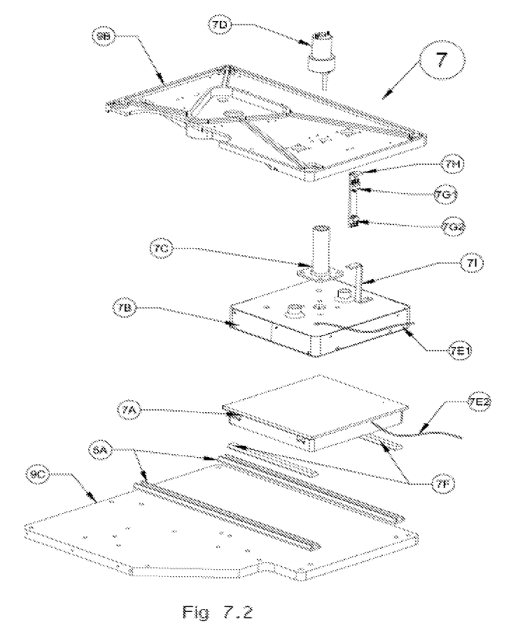

Referring to FIG. 7.1 and FIG. 7.2, the Baking Module (7) is provided that facilitates the process of uniform baking of the said flat edibles. Said Baking Module (7) is comprised of:
Baking Lower Tawa Assembly (7A)
Baking Upper Tawa Assembly (7B)
Baking Actuator Assembly (7C)
Baking Motor (7D)
Upper Tawa Temperature Sensor (7E1)
Lower Tawa Temperature Sensor (7E2)
Guide Block (7F)
Sensor (7G1)
Sensor (7G2)
Sheet Metal Bracket (7H)
Sheet Metal Bracket (7I)

The Baking Module (7) comprises of a pair of Tawa assemblies which includes Baking Lower Tawa Assembly (7A) and Baking Upper Tawa Assembly (7B). Surfaces of said pair of tawas coming in contact with the said flat edibles are smooth and coated with heat resistant non-stick food grade material which includes Polytetrafluroethylene (PTFE) and alike. Said Baking Lower Tawa Assembly (7A) and Baking Upper Tawa Assembly (7B) are a fabricated box shape structure having heat source located inside. Said Heat source is attached to top surface of the said Baking Lower Tawa Assembly (7A) and the bottom side of the said Baking Lower Tawa Assembly (7A) is enclosed by the heat resistant material which includes glass wool, ceramic wool, mineral wool, ceramic cloth and alike in order to minimize the heat loss. Said heat source is attached to the bottom side of said Baking Upper Tawa Assembly (7B) and the top side of the said Baking Upper Tawa Assembly (7B) is enclosed by the heat resistant material, which includes glass wool, ceramic wool, mineral wool, ceramic cloth and alike in order to minimize the heat loss. Said heat source can be in varied range of shapes more preferably in a zig-zag, z type or circular shape. Said Baking lower Tawa Assembly (7A) is attached to a Guide Block (7F), which further slides inside Guide Rail (5A). Said Guide Rail (5A) is attached to a Bottom Plate (9C). Said Baking Upper tawa Assembly (7B) is attached to the Baking Actuator Assembly (7C), which in turn attached to the Baking Motor (7D). Said Baking Motor (7D) is mounted on a top plate (9B). Sheet Metal Bracket (7H) and Sheet Metal Bracket (7I) are provided to hold the sensors. Said Sheet Metal Bracket (7H) is attached at the bottom side of a Top Plate (9B). Said sensors, Sensor (7G1) and Sensor (7G2) are held inside the Sheet Metal Bracket (7H). Said Sheet Metal Bracket (7I) is attached to the Baking Upper tawa Assembly (7B). Upper Tawa Temperature Sensor (7E1) and Lower Tawa Temperature Sensor (7E2) are attached to the said Baking Upper tawa Assembly (7B) and Baking Lower Tawa Assembly (7A) respectively.

The Electronic Module (8), is provided for the automated control of the present automatic machine for making flat edibles (1). Said module is comprised of:
Controller Card PCB (8A)
Switched Mode Power Supply (SMPS) (8B)
Display LCD (8C)
Keyboard (8D)

Said Controller Card PCB (8A), Display LCD (8C) and Keyboard (8D) are mounted on enclosure panels (9A). Said Switched-Mode Power Supply (SMPS) (8B) is mounted on bottom plate (9B). Said Controller Card PCB (8A) is provided that controls the entire process of making flat edibles in the present automatic machine for making flat edibles (1). The list of the functions of the said Controller Card PCB (8A) is as below:
Controls Selection of size of flat edibles.
Controls the activation and deactivation of said temperature sensors Upper Tawa Temperature Sensor (5F1), Lower Tawa Temperature Sensor (5F2), Upper Tawa Temperature Sensor (7E1), Lower Tawa Temperature Sensor (7E2)
Monitors and maintains temperature of said tawas Pressing Lower Tawa Assembly (5C), Pressing Upper Tawa Assembly (5D), Baking Lower Tawa Assembly (7A), Baking Upper Tawa Assembly (7B).
Controls the activation and deactivation of said motors including Conveyor Motor (2C), Agitator motor (2D), Up-down Motor (3E), Motor (3O), Dough base Motor (3G), Dough arm Motor (4E), Roller motor (4G), Pressing Motor (5G), Flat edible arm Motor (6H), Baking Motor (7D).
Controls the activation and deactivation of said Peristaltic pumps (2P).

Said Display LCD (8C) facilitates automatic operation of the said automatic machine for making flat edibles (1) by enabling the parameters such as number of flat edibles to make, thickness of the flat edibles, entered by the user through Keyboard (8D).

The Body and Structural parts module (9), consist of the entire present Automatic Machine for Making Flat edibles (1). Said module is comprised of
Enclosure Panels (9A)
Top Plate (9B)
Bottom Plate (9C)
Pillars (9D)
Sheet Metal Cage (9E)

Said Dispensing module (2) is mounted on top plate (9B). Said Sheet metal bracket (3D) of Kneader module (3) and Dough Arm Motor Cover (4F) is mounted on Bottom Plate (9C). Said Pressing Motor (5G) is attached to the Pressing Motor Base (5H) and is mounted on a top plate (9B). Guide rail (5A) of said Pressing module (5) is mounted on Bottom plate (9C). Further said entire Flat edible arm Module (6) is held inside the Bottom Plate (9C) through a pair of Pillars (9D). Said Baking Motor (7D) is mounted on Top Plate (9B). Said Sheet metal bracket (7H) is attached to Top Plate (9B). Further said Controller Card PCB (8A), Display card (8C) and Keyboard (8D) are mounted on enclosure panels (9A). Said Switched-Mode Power Supply (8B) is mounted on Bottom plate (9B).

### WORKING OF THE INVENTION

Present Automatic machine for making flat edibles (1) is turned ON and the raw materials; wherein said raw materials generally, but not exclusively include flour, water and oil, is fed in the Flour Jar (2J), Water Jar (2L) and Oil Jar (2O) respectively. User enters the parameters for making of the flat edibles such as number of flat edibles to make, thickness of flat edibles; through Keyboard (8D) provided in the said Electronic module (8). Said input parameters are displayed on the Display LCD (8C) of the Electronic Module (8). The thickness of the flat edibles can be decided by varying the range of input parameters of said raw materials. Said varying range of input parameters are provided below in Table: 1

TABLE 1
Shows the range of Input parameters for Flour, Water,
Oil for varied Thickness of Flat edibles.

| Type of Flat | | | |
|---|---|---|---|
| edible(Input | Flour | Water | Oil |
| Parameter) | (Grams) | (ml) | (ml) |
| Thin | 12-15 | 10-12 | 0-5 |
| Medium | 13-18 | 12-20 | 0-8 |
| Thick | 18-25 | 20-25 | 0-10 |

Said Controller Card PCB (8A) further sends the signal to the Up-Down Motor (3E) to start; wherein the Up-Down Motor (3E) moves in upward direction and stops at the required position further facilitating the dispensing of the said raw materials. Controller Card PCB (8A) sends the signal to start the Conveyer Motor (2C), Agitator Motor (2D) and Peristaltic Pumps (2P) for dispensing of the said raw materials. Said Peristaltic Pumps (2P) are activated by the software program. Said Peristaltic Pumps (2P) attached to the water jar (2L) and oil jar (2O) through valve push pin (2N) and jars activated by the valve push pin, regulates the amount of raw material to be dispensed according to the input parameters set by the user through Keyboard (8D). Dispensing of the dry flour from the Flour Jar (2J) starts on activation of said Screw Conveyor (2B) and said Sensor (2R) which in turn is controlled by the Conveyor Motor (2C). Said Fins (2K) rotates through the dry flour to disturb the dry flour in the Flour jar (2J) and thus moves the dry flour towards said Screw Conveyor (2B). Dry flour is dispensed from the said Screw Conveyor (2B) through the Screw Conveyor Holder (2A) to Kneading Module (3). Dispensing of water and oil starts simultaneously along with the dispensing of the dry flour. Said Liquid non return Valve (2M) attached to the said Water Jar (2L) and Oil Jar (2O) prevents the leakage and further facilitates in easy cleaning of the said jars.

On completion of dispensing of the said raw materials, Controller card PCB (8A) sends the signal to stop the Conveyor Motor (2C), Agitator Motor (2D), and Peristaltic pump (2P) and further sends the signal to start the Motor (3O) and Dough Base Motor (3G).

The process of Kneading of the said raw materials starts in the kneading Module (3). Said Dough Base (3I) is lifted up along with the Up-Down Platform (3A), the movement of which is controlled by the said Up and Down Motor (3E), thus closing the Dough Cup (3J) from bottom side. When Up-down platform (3A) reaches the destination, Upper limit switch (3P1) gets actuated and sends signal to controller to stop the Up-down Motor (3E). The said dispensing module (2) dispenses the raw materials as per set input parameters into the said Dough Cup (3J). The Kneader (3K1) along with the Dough Base (3I) are rotated in the two opposite directions to provide the movement and friction to the ingredients in side dough cup (3J), mixing the said raw materials and kneading until a spherical shaped dough ball is formed on to the Dough base (3I). The softness of the said Dough is measured by the Motor (3O) which in turn is activated by Controller card PCB (8A) based on the set input parameters. The time and the number of rotations of the Kneader (3K1) and Dough Base (3I) are controlled by Controller card PCB (8A) based on the set input parameters. After achieving the required softness and spherical shape of dough, Controller card PCB (8A) sends signal to stop the Motor (3O), Dough Base Motor (3G) and signals to start Up-down motor (3E) for downward movement of said Up-down Platform (3A) which further stops on reaching the home position. When Up-down platform (3A) reaches the home position, Lower limit switch (3P2) gets actuated and sends signal to Controller card PCB (8A) to stop the Up-down motor (3E). Said spherical dough ball is then rested at the center of the Dough Base (3I) and further transferred to Pressing Module (5) through Dough Arm module (3).

Controller card PCB (8A) sends signal to start Dough arm Motor (4E) and Roller Motor (4G) to transfer the said spherical dough to the Pressing Module (5). Said motors start the movement of Dough fixed arm (4A) and pair of hollow rollers; Long Roller (4C) and Short Roller (4D). The Dough fixed arm (4A) is specifically designed in “L” shape that facilitates the movement of said rollers and thereby transfers the spherical dough in the form of an arc from the Dough Base (3I) to the center of the Pressing Module (5). Said Long Roller (4C) and Short Roller (4D) keeps rotating the spherical dough and thus avoids sticking of the dough. Said rollers can be easily removed and cleaned. Controller card PCB (8A) stops the Roller Motor (4G) and reverses the Dough arm Motor (4E) after the dough has been transferred.

Controller Card PCB (8A) after stopping the Dough arm motor (4E), sends signal to start Flat edible Arm Motor (6H) which in turn actuates the Dough Locator (6C) to center the said spherical dough onto the Pressing Module (5). After the said spherical Dough has been transferred to the Pressing Module (5) of the present Automatic machine for making Flat edibles (1), pressing of the said dough into flat spherical shape is carried out by pair of pressing tawa assemblies comprising of Pressing Lower Tawa Assembly (5C) and Pressing Upper Tawa Assembly (5D). Pressing Motor (5G) actuates linear motion of the said Pressing Upper Tawa Assembly (5D) due to pressing Actuator Assembly (5E); further where the Pressing Lower Tawa assembly (5C) remains stationary. Temperature for the said tawa assemblies varies with the varying selection of temperatures depending on the size of flat edibles i.e. thin, medium, thick as shown in the Table: 2.

TABLE 2
Shows temperature range for pressing tawa assembly.

| Tawa | Temperature (Deg C.) |
|---|---|
| Upper Tawa | 70 to 140 |
| Lower Tawa | 80 to 180 |

Said temperature range is achieved using Upper Tawa Temperature Sensor (5F1) and Lower Tawa Temperature Sensor (5F2). Controller Card PCB (8A) sends signal to the said temperature sensors (5F1) and (5F2) and based on the selection of flat edibles type i.e. thin, medium or thick and starts the heating of the tawa assemblies. Sheet Metal Bracket (5I) at the bottom of the Top Plate (9B) activates the sensors (5K1) and (5K2) and actuates the Up-down Movement of Pressing Upper Tawa Assembly (5D) for making flat edibles. The size of the flat edibles made can be varied accordingly as shown in Table:3

TABLE 3
Shows relation between thickness and diameter offlat edibles

| Thickness (mm) | Diameter (mm) |
|---|---|
| 1 to 3 | 140 to 180 |

Controller Card PCB (8A) sends signal to stop the Pressing Module (5) and start Flat edible arm Motor (6H). Said motor actuates Horizontal arm (6B) and Vertical arm (6D) and transfers the flattened edible to the Baking Module (7). Further the U Clip (6L) activates the sensor 2 (6M2) which further sends the signal to the Controller Card PCB (8A) to reverse the Flat edible arm Motor (6H), furthermore sensor 1 (6M1) sends signal to stop the said motor.

After stopping the Flat edible arm Motor (6H), Controller card PCB (8A) sends signal to start the Baking motor (7D) which moves down the baking Upper tawa Assembly (7B). Said tawa assemblies acquire the required temperature by the Upper Tawa Temperature sensor (7E1) and Lower Tawa Temperature sensor (7E2). The Baking Upper tawa Assembly (7B) lowered baking actuator Assembly (7C) and further bakes the flat edible uniformly. Temperature of the tawa assembly is controlled for uniform baking as provided by Table 4.

TABLE 4
Shows the Baking Temperature for the Tawa Assemblies

| Tawa | Temperature (Deg C.) |
|---|---|
| Upper Tawa | 200 to 350 |
| Lower Tawa | 200 to 350 |

Baking time for each flat edible is controlled and after completion of the stipulated time of baking of flat edibles the Controller Card PCB (8A) sends the signal to start baking motor (7D) for the upward motion of The Baking Upper Tawa Assembly (7B), Further Sensor (7G1) gets actuated and sends signal to Controller Card PCB (8A) to stop the baking Motor (7D). Controller Card PCB (8A) now sends the signal to Flat edible arm Motor (6H) to turn on which moves the Horizontal arm (6B) and vertical arm (6D) forward to transfer the baked flat edible to the outside tray. Further the U Clip (6L) activates the sensor 2 (6M2) which further sends the signal to the Controller Card PCB (8A) to reverse the Flat edible arm Motor (6H), furthermore sensor 1 (6M1) sends signal to stop the said motor.

### Advantages of Present Invention

1. Present automatic machine for making flat edibles provides a compact machine that automatically dispenses flat edibles that are ready to eat.
2. It further facilitates cleaning of its component parts thereby enabling maintenance of hygienic condition.
3. Present automatic machine for making flat edibles is portable, efficient and cost-effective.
4. It eliminates the requirement of manual process of dough kneading and thus provides the automatic mechanism for kneading of spherical dough.
5. It provides a perfect spherical shaped smooth, soft dough for making of flat edibles in substantially less time.
6. It addresses the limitation of accuracy and uniformity in the process of making flat edibles and thus provides accurate and uniformly baked flat edibles.
7. It provides modular structure machine which further facilitates in assembling and disassembling of the component parts of said machine and thus aids in cleaning of the said machine and maintain hygienic conditions.
8. It provides safely operated automatic machine with the provisions of plurality of temperature sensors which further facilitates the machine to auto stop in case of overheating, and thereby also saves energy.
9. It requires considerably less amount of utilities.
10. It further provides the user friendly compact machine, easy to use even for the unskilled users.

1. An automatic machine for making flat edible (1), comprises of:
Dispensing Module (2),
Kneading Module (3),
Dough arm Module (4),
Pressing Module (5),
Flat edible arm Module (6),
Baking Module (7),
Electronic Module (8),
Body and Structural Parts (9);
wherein
said Dispensing Module (2) is provided to dispense the raw materials in the present automatic machine for making flat edibles (1) for preparing the flat edibles, wherein said raw materials generally, but not exclusively include flour, water and oil;
Said Dispensing Module (2) further comprises of:
Screw Conveyor Holder (2A),
Screw Conveyor (2B),
Conveyor motor (2C),
Agitator Motor (2D),
Agitator Female Coupling A (2E),
Agitator Male Coupling (2F),
Agitator Female Coupling B (2G),
Jar Locking Disc (2H),
Flour Jar Disc (2I),
Flour Jar (2J),
Fins (2K),
Water Jar (2L),
Liquid Non Return Valve (2M),
Valve Push Pin (2N),
Oil Jar (2O),
Peristaltic pump (2P),
Four Spread Stopper (2Q),
Sensor (2R),
wherein further,
said Screw conveyer holder (2A) is made of food grade high strength plastic; which includes Polyethylene Terephthalate (PET), Polypropylene (PP), High-Density Polyethylene (HDPE), low-Density Polyethylene (LDPE), Polycarbonate (PC), Nylon, Acrylonitrile Butadiene Styrene (ABS) and is mounted on a top plate (9B); a Screw Conveyer (2B) made do food grade high strength plastic which includes Polyethylene Terephthalate (PT), Polypropylene (PP), High-Density Polyethylene (HDPE) Low-Density Polyethylene (LDPE), Polycarbonate (PC), Nylon, Acrylonitrile Butadiene Styrene (ABS) is provided, to smoothly meter and transfer the amount of flour needed for making of flat edibles based on the input from the Controller Card PCB (8A); said Screw conveyer (2B) is held inside the screw conveyer holder (2A) wherein said Screw conveyor (2B) is controlled by the Conveyor Motor (2C) which in turn is attached to a Sensor (2R); said Flour Spread Stopper (2Q) is attached to said Screw Conveyor Holder (2A) and is provided to stop extra four spreading said Flour Jar (2J) made up of food grade high strength plastic which includes Polyethylene terephthalate (PET), Polypropylene (PP), High-Density Polyethylene (HDPE), Low-Density Polyethylene (LDPE), Polycarbonate (PC), Nylon, Acrylonitrile Butadiene Styrene (ABS) is provided to facilitate easy lift out without spilling the flour inside the said machine with the lid to load the dry flour for making flat edibles, further where said Flour Jar (2J) is attached to the Flour Jar Disc (2I) said Flour Jar disc (2I) is attached to jar locking disc (2H), wherein bottom side do Jar locking disc (2H) is attached to the Screw Conveyer Holder (2A); and said Flour jar (2J) is mounted on a Top Plate (9B); Fins (2K), an Agitator Female Coupling A(2E), an Agitator Male Coupling (2F) and an Agitator Female Coupling B(2G) are attached to a Agitator Motor (2D) in the center of said Flour Jar (2J) wherein said Agitator motor (2D) is regulated by Controller Card PCB (8A) to regulate the process of dispensing; furthermore a Water Jar (2L) made up food grade high strength plastic which inclludes Polyethylene Terephthalate (PET), Polypropylene (PP) High-Density Polyethylene (HDPE), Low-Density Polyethylene (LDPE), Polycarbonate (PC) Nylon, Acrylonitrile Butadiene Styrene (ABS is provided for storing of water required in the process of making of flat edibles wherein said Water jar (2L) is mounted on a Top Plate (9B); an Oil Jar (2O) made up food grade high strength plastic which includes Polyethylene Terephthalate (PET), Polypropylene (PP), High-Density Polyethylene (HDPE), Low-Density Polyethylene (LDPE), Polycarbonate (PC), Nylon, Acrylonitrile Butadiene styrene (ABS) is provided far storing of oil, molten butter, molten ghee or required in the process of making of flat edibles wherein said Oil Jar (2O) is mounted on a Top Plate (9B); a Liquid non-return Valve (2M) is activated by the Valve Push Pin (2N) when said Water Jar (2L) or Oil Jar (2O) is mounted on Top Plate (9B); a pair of Peristaltic Pump (2P) made of food grade material which includes Polyethylene Terephthalate (PET), Polypropylene (PP), High-Density Polyethylene (HDPE), Low-Density Polyethylene (LDPE), Polycarbonate (PC), Nylon, Acrylonitrile Butadiene styrene (ABS is provided for dispensing of water and oil from the said Water jar (2L) and Oil jar (2O), said Dispensing Module (2) is mounted on a top plate (9B) said Kneading Module (3) is provided for mixing and kneading of raw materials dispensed in said module (3) through dispensing module (2) and further facilitates in making of spherical shape dough in the present automatic machine for making flat edibles (1) wherein said raw materials generally, but not exclusively in de flour, water and oil; Said Kneading Module (3) is further comprised of:
Up-Down Platform (3A),
Lead Screw (3B),
Coupling (3C),
Sheet Metal Bracket (3D),
Up-Down Motor (3E),
Pressure Pad (3F),
Dough Base Motor (3G),
Dough Swivel (3H),
Dough Base (3I),
Dough Cup (3J),
Kneader (3K1),
Magnet 1 (3K2),
Dough Cup Holder (3L),
Kneader Holder (3M1),
Magnet 2 (3M2),
Motor Base (3N),
Motor (3O),
Upper Limit Switch (3P1),
Lower Limit Switch (3P2);
Wherein further, said kneader (3K1) is provided with magnet 1 (3K2) that facilitates the rotation and mixes the said raw materials into spherical dough; further where said raw materials generally, but not exclusively include flour, water and oil; said Kneader (3K1) is attached to Kneader holder (3M1) and Magnet (3M2), controlled by a Motor (3O) which in turn is controlled by the said Controller card PCB (8A) wherein said Kneader (3K1) is a specifically designed finger like structure, further said Kneader (3K1) and magnet (3K2) rotates inside the Dough cup (3J) having four holding bosses and is open from the top as well as the bottom side which in turn is attached to the Dough cup Holder (3L), said dispensed raw materials are held inside the Dough cup (3J) and Doug Base (3I); said Dough Base (3I) having a ribbed surface on the top face and grooves on cylindrical face is attached to the Dough base Motor (3G) and said Dough swivel (3H) which in turn is attached to the Up-down Platform (3A); said Up-down Platform (3A) is attached to the Dough base Motor (3G), said Dough Base Motor (3G) is controlled by the said Controller card PCB (8A) further where a Lead Screw (3B) driven by the Up-down motor (3E) is provided to facilitate the up down movement of the said Up-Down Platform (3A); Coupling (3C) is provided for absorbing shocks and jerks during up and down movements of the said up down platform (3A) and during Kneading operations wherein said Kneader (3K1), Dough cup (3I), Dough Base (3I) and Dough swivel Base (3H) have been designed such that it can be detached easily and thereby ease the process of cleaning of the said component parts thus, maintains hygienic conditions;
said Dougharm Modate (4) is provided to transder the said spherical dough at aposition that ease the process of making flat edibles and then returns back to the home position of said dough arm module;
said module is further comprised of:
Dough Fixed Arm (4A),
Roller Arm (4B),
Long Roller (4C),
short Roller (4D),
Dough Arm Motor (4E),
Dough Arm Motor Cover (47),
Roller Motor (4G);
wherein further,
said Dough fixed am (4A) is provided to facilitate the transfer of spherical dough to the Pressing Module (5) which further rotates at an angle in the range of 0-200° further said Dough fixed arm (4A) is attached to the Dough arm Motor (4E) which in turn is attached to the Dough arm Motor Cover (4F) wherein said Dough arm Motor Cover (4F) consists of a sensor for sensing the home position of the Dough fixed Arm (4A); a Roller arm (4B) is attached to the said Dough fixed arm (4A) which consist of a Long Roller (4C) and Short Roller (4D) made up at food grade plastic which includes Polyethylene Terephthalate (PET), Polypropylene (PP), High-Density Polyethylene (HDPE), Low-Density Polyethylene (LDPE), Polycarbonate (PC), Nylon, Acrylonitrile Butadiene Styrene (ABS) which is provided in a specific “L” shaped arrangement to facilitate the smooth transfer of the spherical dough further said specific “L” shaped arrangement further facilitates the movement of the said rollers and guides the dough during the transfer, said Roller motor (4G) is provided to facilitate the rollers to rotate and aid in the process of transferring the spherical dough wherein said Roller Motor (4G) is attached to Long roller (48) and Dough fixed arm (4A);
said Pressing Module (5) is provided which facilitates in the complete process at making of flat edibles in the present automatic machine for making flat edibles (1), by pressing the spherical dough transferred by the said Dough Arm Module (4) into a flat round edible;
said module is further comprised of:
Guide Rail (5A),
Guide Block (5B),
Pressing Lower Tawa Assembly (5C),
Pressing Upper Tawa Assembly (5D),
Pressing Actuator Assembly (5E),
Upper Tawa Temperature Sensor (5F1),
Lower Tawa Temperature sensor (5F2),
Pressing Motor (5G),
Pressing Motor Base (5H),
sheet Metal Bracket (5I),
Sheet Metal Bracket (5J),
Sensor (5K),
sensor (5K2);
wherein further,
said Pressing Module (5) comprises of a pair of tawas, Lower Tawa Assembly (5C) and Pressing Upper Tawa Assembly (5D) wherein surfaces of said pair of tawas coming in contact with the said spherical dough are smooth and coated with heat resistant non-stick food grade material; which includes Polytetra fluoroethylene (PTFE) further where said Pressing Lower Tawa Assembly (5C) is a fabricated box shape structure having heat source located inside wherein said Heat source is attached to top surface of the said Pressing Lower Tawa Assembly (5C) where said Pressing Upper tawa Assembly does not consists of heat source; the bottom side of the said heat source is surrounded with heat resisting material which includes Polytetra fluoroethylene (PTFE) to minimize heat losses due to convection wherein said heat source can be in varied range of shapes more preferably in a zig-zag, z type or circular shape; said Pressing lower Tawa Assembly (5C) is attached to a Guide Block (5B), which further slides inside Guide Rail (5A) which in turn is attached to a Bottom Plate (9C) further said Pressing Upper tawa Assembly (5D) is attached to the Pressing Actuator Assembly (5E), which in turn is attached to the Pressing Motor (5G) wherein said Pressing Motor (5G)) is attached to the Pressing Motor Base (5H) and is mounted on a top plate (9B); sheet Metal Bracket (5I) attached at the bottom side of a Top Plate (9B) and Sheet Metal Bracket (5J) are provided to hold the sensors, said sensors, Sensor (5K1) and Sensor (5K2) are held inside the Sheet Metal Bracket (5I) further said Sheet Metal Bracket (5J) is attached to the Pressing Upper tawa Assembly (5D); said Upper Tawa Temperature Sensor (5F1) and Lower Tawa Temperature Sensor (5F2) are attached to the said Pressing Upper tawa Assembly (5D) and Pressing Lower Tawa Assembly (5C) respectively; said Plat edible arm Module (6) is provided to transfer the said flat round edible from the Pressing Module (5) to the Baking Module (7), to transfer the baked edible from the Baking Module (7) to a outside tray and thus facilitate in the completing the process for making of flat edibles; Said Flat edible-arm Module (6) is further comprised a:
Pusher (6A),
Horizontal arm (6B),
Dough Locator (6C),
Vertical arm (6D),
Pulley A (6E),
Pulley B (6),
Wire Rope (6G),
Flat edible arm Motor (6H),
Guide Block (6I)),
Rail Guide (6J),
Flat edible arm Body (6K),
U clip (6L),
Sensor 1 (6M1),
Sensor 2 (6M2);
wherein further
said Pusher (6A) made up of food grade material which includes Polyethylene Terephthalate PE), Polypropylene (PP), High-Density Polyethylene (HDPE), Low-Density Polyethylene (LDPE), polycarbonate (PC), Nylon, Acrylonitrile Butadiene Styrene (ABS), Dough Locator (6C) are mounted on the Horizontal arm (6B) wherein said Horizontal arm (6B) is attached to the Vertical Arm (6D) which facilitates the motion in the transfer of flat edibles, said Vertical Arm (6D) is connected to the U Clip (6L) which in turn is attached to the Guide Block (6I) further which is attached to the Wire Rope (6G) and Wire Rope (6G) is attached to Pulley A (6E) and Pulley B (6F); Wire Rope (6G) facilitates the linear motion of Guide Block (6I) guided in Rail Guide (6J); Rail Guide (6J) fixed upon the Flat edible arm Body (6K); a pair of sensors, Sensor (6M1) and Sensor (6M2) are attached to the side ends of the Flat edible arm Body (6K) which are further regulated by the Controller Card PCB (8A), said Flat edible arm Motor (6H) is attached to the Pulley A (6E) said entire Flat edible arm Module (6) is held-above the Bottom Plate (9C) through a pair of Pillars (9D);
said Baking Module (7) is provided that facilitates the process of uniform baking of the said flat edibles;
said Baking Module (7) is further comprised of:
Baking Lower Tawa Assembly (7A),
Baking Upper Tawa Assembly (7B),
Baking Actuator Assembly (7C),
Baking Motor (7D),
Upper TawaTemperature Sensor (7E1),
Lower TawaTemperature Sensor (7E2),
Guide Block (7F),
Sensor (7G1),
Sensor (7G2),
Sheet Metal Bracket (7H),
Sheet Metal Bracket (7I);
wherein further,
Baking Module (7) comprises of a pair of Tawa assemblies which includes Baking Lower Tawa Assembly (7A) and Baking Upper Tawa Assembly (7B) wherein surfaces of said pair of tawas coming in contact with the said flat edibles are smooth and coated with heat resistant non-stick food grade material includes Poly tetra fluoroethylene (PTFE); said Baking Lower Tawa Assembly (7A) and Baking Upper Tawa Assembly (7B) are a fabricated box shape structure having heat source located inside wherein said Heat source is attached to top surface of the said Baking Lower Tawa Assembly (7A) and the bottom aide of the said Baking Lower Tawa Assembly (7A) is enclosed by the heat resistant material which includes glass wool, ceramic wool, mineral wool, ceramic cloth, to minimize the heat loss further said heat source is attached to the bottom side do said Baking Upper Tawa Assembly (7B) and the top side of the said Baking Upper Tawa Assembly (7B) is enclosed by the heat resistant material which includes glass wool, ceramic wool, mineral wool, ceramic cloth, to minimize the heat loss wherein said heat source can be in varied range of shapes more preferably in a zig-zag z type or circular shape; said Baking lower Tawa Assembly (7A) is attached to a Guide Block (7F), which further slides inside Guide Rail (5A) attached to a Bottom Plate (9C), said Baking Upper tawa Assembly (7B) is attached to the Baking Actuator Assembly (7C), which in turn attached to the Baking Motor (7D) mounted on a top plate (9B), Sheet Metal Bracket (7H) and Sheet Metal Bracket (7I) are provided to hold the sensors, said Sheet Metal Bracket (7H) is attached at the bottom side of a Top Plate (9B) wherein said sensors, Sensor (7G1) and Sensor (7G2) are held upon the Sheet Metal Bracket (7H) further said Sheet Metal Bracket (7I) is attached to the Baking Upper tawa Assembly (7B) furthermore said Upper Tawa Temperature Sensor (7E1) and Lower Tawa Temperature Sensor (7E2) are attached to the said Baking Upper tawa Assembly (7B) and Baking Lower Tawa Assembly (7A) respectively;
said Electronic Module (8), is provided far the automated control of the present automatic machine for making fat edibles (1); said module is further comprised of:
Controller Card PCB (8A)
Switched Mode Power Supply (SMPS) (8B)
Display LCD (8C)
Keyboard (8D)
wherein further,
said Controller Card PCB (8A), Display card (8C) and Keyboard (8D) are mounted on enclosure panels (9A); said Switched-Mode Power Supply (SMPS) (8B) is mounted on bottom plate (9B);
said Controller Card PCB (8A) is provided that controls the entire process of making flat edibles in the present automatic machine for making flat edibles (1) further where the functions of the said Controller Card PCB (8A) includes:
Controls election of size of flat edibles,
Controls the activation and deactivation of said temperature sensors Upper Temperature Sensor (5F1), Lower Temperature Sensor (5F2), Upper Temperature Sensor (7E1), Lower Temperature Sensor (7E2),
Monitors and maintains temperature of said tawas Pressing Lower Tawa Assembly (5C), Pressing Upper Tawa Assembly (5D), Baking Lower Tawa Assembly (7A), Baking Upper Tawa Assembly (7B),
Controls the activation and deactivation of said motors including Conveyor Motor (2C), Agitator motor (2D), Up-down Motor (3E), Motor (3O), Dough base Motor (3G), Dough arm Motor (4E), Roller motor (4G), Pressing Motor (5G), Flat edible arm Motor (6H), Baking Motor (7D),
Controls the activation and deactivation of said Peristaltic pumps (2P);
Said Display LCD (8C) facilitates automatic operation of the said machine by enabling the parameters such as number of fat edibles to make, thickness of the flat edibles, entered by the user through Keyboard (8D), said Body and Structural parts (9), consist of the entire present Automatic Machine for Making edibles (1); said module is comprised of:
Enclosure Panels (9A)
Top Plate (9B)
Bottom Plate (9C)
Pillars (9D)
Sheet Metal Cage (9E)
Wherein further,
said Dispensing module (2) is mounted on top plate (9B); said Sheet metal bracket (3D) of Kneader module (3) and Dough Arm Motor Cover (4F) is mounted on Bottom Plate (9C) further said Pressing Motor (5G) is attached to the Pressing Motor Base (5H) and is mounted on a top plate (9B); said Guide rail (5A) of said Pressing module (5) is mounted on Bottom plate (9C); further said entire Flat edible arm Module (6) is held inside the Bottom Plate (9C) through a pair of Pillars (9D); said Baking Motor (7D) is mounted on Top Plate (9B); said Sheet metal bracket (7H) is attached to Top Plate (9B), further said Controller Card PCB (8A), Display card (8C) and Keyboard (8D) are mounted on enclosure panels (9A); said Switched-Mode Power Supply (8B) is mounted on Bottom plate (9B).

2. Automatic machine for making flat edibles (1), as claimed in claim 1, wherein said kneader (3K1) of Kneading Module (3) is a finger like structure more preferably 5 fingers or 4 fingers or 3 fingers like structure.

3. Automatic machine for making flat edibles (1), as claimed in claim 1, wherein said Dough fixe arm (4A) of the Dough arm Module (4) is rotatable at an angle in the range of 0-200° to facilitate the transfer of spherical dough to the Pressing module (5).

4. Automatic machine for making flat edibles (1), as claimed in claim 1, wherein said Long Roller (4C) and Short Roller (4D) of the Dough arm Module (4) are provided in a specific “L” shaped arrangement to facilitate the smooth transfer of the spherical dough.

5. Automatic machine for making flat edibles (1), as claimed in claim 1, wherein no separate heat source is provided for Upper Tawa assembly (5D) of the said Pressing Module (5).

6. Automatic machine for making flat edibles (1), as claimed in claim 1, wherein said Heat source of the Pressing Module (5) and Baking Module (7) is in varied range of shapes more preferably in a zig-zag, z type or circular shape.

7. Automatic machine for making flat edibles (1), as claimed in claim 3, wherein said Long Roller (4C) and Short Roller (4D) of the Dough arm Module (4) are provided in a specific “L” shaped arrangement to facilitate the smooth transfer of the spherical dough.
